(19) United States
(12) Patent Application Publication
(10) Pub. No.: US 2004/0071811 A1
(43) Pub. Date: Apr. 15, 2004

(54) Rotational moulding machine

(76) Inventor: Paul Vincent Meuret, Abidjan (CI)

Correspondence Address: Nixon & Vanderhye, 8th Floor, 1100 North Glebe Road, Arlington, VA, 22201-4714, US

(21) Appl. No.: 10/467,375

(22) PCT Filed: Feb. 4, 2002
(86) PCT No.: PCT/EP02/01127

(30) Foreign Application Priority Data
Feb. 9, 2001 (GB) 0103297.8

(51) Int. Cl. B29C 41/04

(52) U.S. Cl. 425/174.4; 425/435

(57) ABSTRACT

A rotational moulding machine comprising: an oven; at least one arm arranged, in use, to rotate a mould within and relative to said oven, said at least one arm having: a connection portion for connecting said mould to said arm; a cabling receiving section for receiving cabling connected between outside of said oven and said connection portion; a first conduit portion for the flow therein of cooling fluid from outside of said oven into said oven towards said connection portion; and a second conduit portion for the return flow therealong of said cooling fluid from inside of said oven to outside of said oven: and a pump for pumping said cooling fluid through said first and second conduit portions; wherein, in use, the pumped flow of said cooling fluid through said first and second conduit portions serves to cool said connection portion and/or said cabling receiving section.

The present invention relates to improvements in rotational moulding machines, particularly, but not exclusively, to rotational moulding machines for providing more operator control during rotational moulding.

Rotational moulding is a technique which is sometimes used to make large articles from plastics materials, for example septic tanks and kayaks. In the technique, a powdered plastics material is placed in a mould and the mould is rotated whilst being heated in an oven. The oven is heated to around 300° C. and the outside of the mould reaches a temperature of about 230° C. The plastics material inside the mould reaches a temperature of only about 180° C. which is the temperature necessary for melting the plastics material to a state in which it flows sufficiently. The duration of heating required depends on the size and intricacy of the mould and may be for as long as half an hour. After heating the mould must be cooled ideally during which rotation is continued. Cooling is often accomplished with the aid of cooling fans and may last for approximately fifteen minutes. This is described in U.S. Pat. No. 4,583,932 which is incorporated herein by way of reference. Both gas fired and infrared ovens can be used.

Previously, to determine the correct moulding conditions including temperature and the rates of rotation of the mould in two directions (which may not be the same or indeed constant), it has been necessary largely to rely on trial and error. The conditions are often determined by problem areas of the mould which require the longest heating duration, for example.

The present invention provides a rotational moulding machine comprising:

an infra red oven;

at least one arm arranged, in use, to rotate a mould within and relative to said oven, said at least one arm having:

a connection portion for connecting said mould to said arm;

a cabling receiving section housing cabling connected between outside of said oven and said connection portion;

a first conduit portion for the flow therein of cooling fluid from outside of said oven into said oven towards said connection portion; and

a second conduit portion for the return flow therealong of said cooling fluid from inside of said oven to outside of said oven; and

a pump for pumping said cooling fluid through said first and second conduit portions; wherein, in use, the pumped flow of said cooling fluid through said first and second conduit portions serves to cool said cabling thereby to protect said cabling from high temperatures in said oven.

The hereinafter described embodiment of the present invention allows for control cabling to be connected between the rotating mould inside the oven and the outside of the oven, enabling this cabling to be used, for example, to increase operator control of the moulding conditions. The control cabling is protected from the harsh high temperature environment inside the oven by a flow of cooling fluid. This opens up the possibility of providing control signals and power to thermocouples and/or additional heaters on or in the mould during use. The cooling fluid also helps to keep any bearings in the arm relatively cool so that lubricating grease does not melt and flow out of the bearing.

The present invention will now be described by way of example only with reference to the following drawings in which;

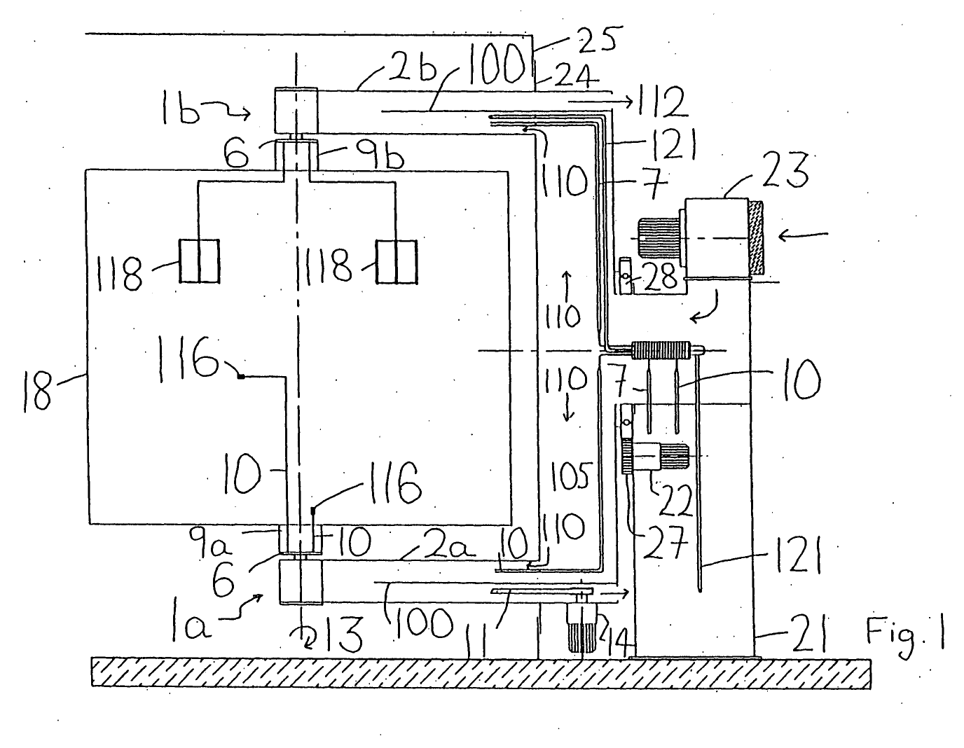

FIG. 1 is a schematic part cross-sectional side elevation of an embodiment of rotational moulding machine according to the present invention; and

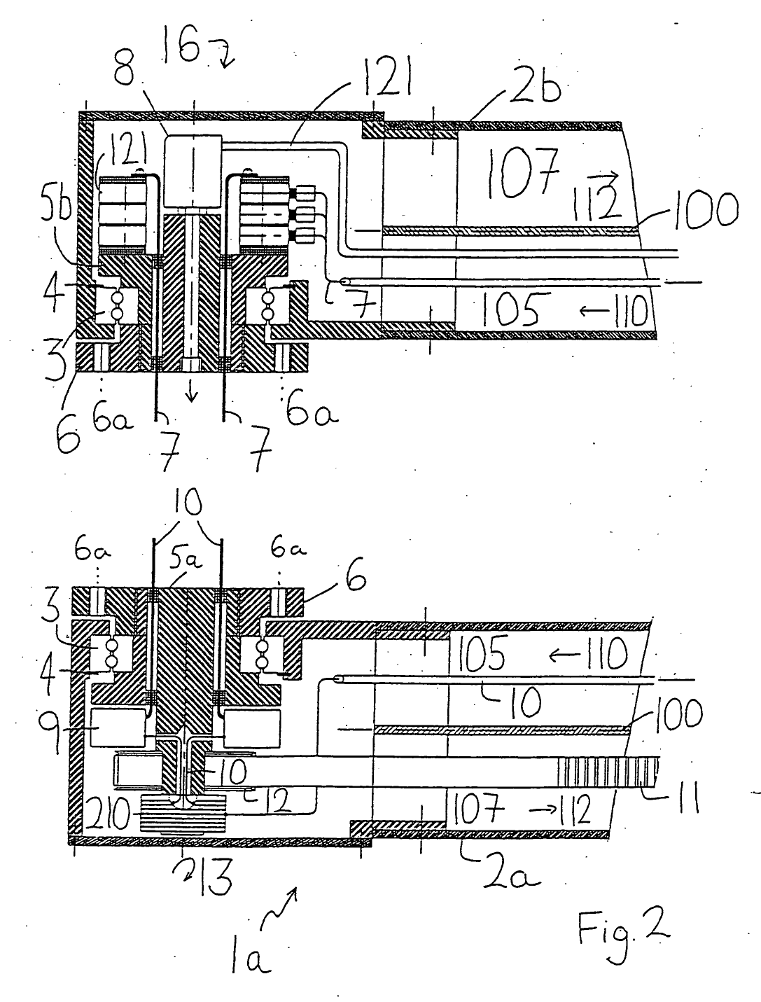

FIG. 2 is a schematic diagram of part of the rotational moulding machine of FIG. 1 showing in detail a cross-sectional side elevation of the connection portions.

Part of a rotational moulding machine in accordance with the present invention is shown schematically in FIG. 1. A mould 18 is situated within an oven 25. The mould 18 is rotatable around a first axis 13 and a second axis 17 orthogonal to the first axis. In the preferred embodiment the oven 25 is fixed to the ground 26 and the oven is an infrared oven providing energy to the mould 18 mainly by radiation from a plurality of infrared sources (not shown in FIG. 1) mounted on the oven's interior. Alternatively the oven 25 may be fired by other means, for example gas in which heat is mainly provided to the mould 18 by convection from hot combustion gases.

The mould 18 is supported in the oven 25 by a first arm 2a and a second arm 2b which are connected to opposite sides of the mould 18. First and second arms 2a, 2b are themselves supported on a vertical post 21 outside the oven. First and second arms are both generally L-shaped and are attached together at the ends of the bases 15 of the L's to form a generally U-shaped frame assembly. The mould 18 is positioned between the open ends of the U-shape.

By rotating first and second arms 2a, 2b around second axis 17 (at which position the first and second arms 2a, 2b are joined), the mould 18 is also rotated around the second axis 17. Although the preferred embodiment shows-a frame supporting a mould and rotating it in two orthogonal directions, the frame according to the present invention may in fact only provide rotation of the mould around only one axis and not provide any support to the mould.

Mould 18 (which is removable from the arms 2a, 2b) is connected to the first and second arms 2a, 2b through connection portions generally denoted 1a and 1b in FIG. 1 which are situated substantially at the ends of the first and second arms 2a, 2b respectively.

Connection portions 1a, 1b engage drivably with attachment portions 9a, 9b which are fixed on opposing surfaces of the mould 18. The connection portions 1a, 1b are arranged to drivably rotate the mould 18. This allows the mould to be rotated around first axis 13. In this way, it is possible to rotate the mould around first axis 13 relative to first and second arms 2a, 2b and around second axis 17 relative to the oven 25.

The first and second arms 2a, 2b are elongate, hollow and generally L-shaped. The two arms meet at the second axis 17 where they are rotatably supported by post 21 and toothed ball bearing 28. A generally circular opening in the side wall of the oven 25, through which the arms fit, is covered with a generally circular baffle 24 which forms part of the frame assembly or is attached thereto. The baffle serves to reduce the amount of heat lost through the opening in the side wall of the oven 25.

As better shown in FIG. 2 the inside of the vertical part of each of the L-shaped arms 2a, 2b (the horizontal parts as illustrated in the figures) is divided into two elongate channels by a dividing member 100 to split the insides of the arms 2a, 2b into a first conduit portion 105 and a second conduit portion 107. The dividing member 100 ends in the proximity of the connecting portion 1a, 1b such that the first and second conduit portions meet in the vicinity of connection portion 1a, 1b Although both of the arms 2a, 2b are divided by a dividing member 100, many of the advantages of the present invention can be realised if only one arm has a first and second conduit portion.

The dividing member 100 is arranged such that the upstream end of the first conduit portion 105 is in communication with a blower 23 on the post 21 and the downstream end of the second conduit portion 107 is open to the surroundings outside of the oven 25 such that cooling gas is vented externally of the oven. The base parts (vertically as drawn in FIG. 1) of the L-shaped arms 2a, 2b are not divided by the dividing member and enclose the first conduit portion 105 only. In this way cooling air is blown by the blower 23 through the first conduit position 105 from outside of the oven 25 in direction 110 along the hollow and elongate section forming the first and second arms 2a, 2b towards the connecting portions 1a, 1b. The air returns through second conduit portions 107 in direction 112 to leave the arm portions 2a, 2b outside of the oven. The flow of air along the first and second conduit portions 105, 107 serves to cool the connection portions 1a, 1b and/or cabling 7, 10 which extends between outside of the oven 25 and the mould 18 and runs in the first conduit portions 105 which act as cabling receiving sections. The cabling may also lie in the second conduit portion 107.

A typical flow rate of cooling fluid in the conduit portions is about 10,000 m³/h from a 4 kW blower. The precise flow rate may be adjusted by flaps. In this way the maximum temperature of the cooling fluid can be kept below about 60° C. Furthermore, by spray covering the outside of the arms in the oven with Aluminium, the resulting reflective surface can reflect infra red radiation thereby also helping to keep the temperature inside the arms low.

In the preferred embodiment, cabling 7, which lies in the second arm portion, is for providing power to extra heaters 118 provided on the mould 18. Those extra heaters can be used to provide extra heating to parts of the mould 18 which benefit from extra energy input in comparison to other areas. For example, this may be useful for intricate parts of the mould 18 where plastic must coat thickly.

In the preferred embodiment, cables 10 which pass through first arm portion 2a are designed for thermocouples 116 which are attached to the mould 18. The information about the temperature of various parts of the mould 18 to which the thermocouples are attached can be useful for controlling the heat input as well as the cooling, and/or varying the rates and/or direction of rotation; this helps to provide better control of the rotational moulding process.

The first and second arms 2a, 2b are rotatable around second axis 17 by the action of a first motor 22 (which may be a gearmotor). A pinion 27 driven by the motor 22 engages the external cogs of ball bearing 28 attached co-axially with second axis 17 to the first and second arms 2a, 2b. The whole arm and mould assembly is rotatably supported by the ball bearing 28, and cooling air passes from the blower 23 into the portion of the two aims 2a, 2b where they are joined and into the first conduit portions 105. The connection of cabling 7, 10 between the post 21 and the first and second arms 2a, 2b is accomplished with a first rotating collector 19 and brushes. Air returning to the outside of the oven 25 through second conduits 107 leaves the arms 2a, 2b through a hole in the base of the L-shape furthest from where the two arm portions are joined.

As is illustrated in detail in FIG. 2, rotation of the mould 18 around the first axis 13 is accomplished by a second motor 14 (which may be a gearmotor) which is attached to the first arm 2a outside of the oven 25. A driving belt 11, usable thanks to the cooling of the cooling fluid, is connected from the second motor 14 to a pulley 12 in the connection portion 1a. The pulley 12 is attached to a shaft 5a which drives the mould 18 around the first axis 13. A second rotating collector 210 on the same shaft 5a allows electrical connection of the thermocouples on the mould to the cabling in the first arm portion 2a via brushes.

A similar rotating collector 211 on shaft 5b and brush arrangement is used in second arm portion 2b for the connection of cabling 7 to the heaters 118 on the mould 18.

In the preferred embodiment, only one second motor 14 is attached to the first arm 2a for rotating the mould 18 relative to the first and second arm portions 2a, 2b. The shafts 5a, 5b are supported by a ball race bearing 3 held in place by an elastic ring 4 in both connection portions 1a, 1b. In the illustrated embodiment a flange 6, attached to the end of the shafts 5a, 5b is provided with a plurality of threaded holes 6a for the attachment thereto of the mould 18.

If required, the shaft 5b of the second arm portion 2b may be hollow such that gas may be provided through rotating coupling 8 and pipes 121 to the mould 18. A similar coupling 20 is provided on the supporting frame 21. For some moulding operations it is required that inert gas is provided to the inside of the mould 18 to avoid oxidation and/or to help keep the polymer adhered to the inside wall of the mould.

Various passages machined in the axial direction through the shafts 5a, 5b allow for the passage of cabling from the rotating collectors 210, 211 to the mould 18. In the case of the thermocouple cabling 10, the cables to pass through thermocouple converters 9 after the collector 210 before entering the mould 18. The converters 9 are attached to the shaft Sa and rotate with it.

The provision of a flow of cooling fluid through the first and second conduits advantageously keeps rotating collectors 210, 211, driving belt 11, pulley 12 and ball race bearings 3 cool to prolong their lifetime and enhance their performance during operation.

1. A rotational moulding machine comprising:
an infra red oven;
at least one arm arranged, in use, to rotate a mould within and relative to said oven, said at least one arm having:
a connection portion for connecting said mould to said arm;
a cabling receiving section housing cabling connected between outside of said oven and said connection portion;
a first conduit portion for the flow therein of cooling fluid from outside of said oven into said oven towards said connection portion; and
a second conduit portion for the return flow therealong of said cooling fluid from inside of said oven to outside of said oven; and
a pump for pumping said cooling fluid through said first and second conduit portions; wherein, in use, the pumped flow of said cooling fluid through said first and second conduit portions serves to cool said cabling thereby to protect said cabling from high temperatures in said oven.

2. A rotational moulding machine according to claim 1, wherein said connection portion is rotatable relative to said arm about a first axis to rotate said mould relative to said at least one arm about said first axis.

3. A rotational moulding machine according to claim 2, wherein said at least one arm is arranged to rotate said mould relative to said oven around a second axis which is substantially orthogonal to said first axis.

4. A rotational moulding machine according to claim 1 wherein said at least one arm is arranged to rotate said mould relative to said oven around a second axis.

5. A rotational moulding machine according to claim 3 or claim 4, further comprising a first motor arranged to rotate each of said at least one arm around said second axis.

6. A rotational moulding machine according to any one of the preceding claims, further comprising;
a first arm and a second arm of said at least one arm;
said respective connecting portions of said first and second arms opposing each other in spaced apart relationship and arranged, in use, on opposing sides of said mould.

7. A rotational moulding machine according to any one of the preceding claims, further comprising a second motor connected outside of said oven to one of said at least one arms; and
a drive belt connected between said first motor and said connection portion; said connection portion thereby being rotatable by said second motor.

8. A rotational moulding machine according to any one of the preceding claims, wherein said first conduit portion and said second conduit portion are on opposite sides of said cabling receiving section.

9. A rotational moulding machine according to any one of the preceding claims, further comprising rotatable electrical connectors for connecting cables on said mould to said cabling in one of said at least one arms.

10. A rotational moulding machine according to any one of the preceding claims, wherein said at least one arm is a elongate, hollow and generally L-shaped.

11. A rotational moulding machine according to any one of the preceding claims, further comprising a rotatable conduit for, in use, providing fluid from one of said at least one arms to said mould.

12. A rotational moulding machine according to any one of the preceding claims, wherein said fluid is air.

13. A rotational moulding machine according to any one of the preceding claims, wherein said cabling receiving section is part of said first conduit portion.

14. A rotational moulding machine according to any one of claims 1 to 12, wherein said cabling receiving section is part of said second conduit portion.

15. A rotational moulding machine according to anyone of claims 1 to 12, wherein a dividing member divides part of said elongate, hollow and generally L-shaped at least one arm into said first and second conduit portions.

16. A rotational moulding machine according to claim 15, wherein said divided part of said arms is in the vertical portion of said L-shape.

17. A method of cooling cabling housed in a cabling receiving section of an arm of a rotational moulding machine, said machine having an infra red oven, and said cabling being connected between outside of said oven and a connection portion connecting a mould inside said oven to said arm, said method comprising the steps of:
providing said arm with a first conduit portion for the flow therein of cooling fluid from outside of an oven towards an end of said arm connected to a mould in said oven;
providing said arm with a second conduit portion for the return flow therealong of said cooling fluid from inside of said oven to outside of said oven;
providing a flow of cooling fluid from outside of said oven to inside said oven through said first conduit portion and out of said oven through said second conduit portion to cool said cabling thereby to protect said cabling from high temperatures in said oven.

18. A rotational moulding machine substantially as herein before described with reference to and as illustrated in the accompanying drawings.

19. A method substantially as hereinbefore described with reference to and as illustrated in the accompanying drawings.
